(19) United States
(12) Patent Application Publication
(10) Pub. No.: US 2016/0112309 A1
(43) Pub. Date: Apr. 21, 2016

(54) INFORMATION PROCESSING APPARATUS, AND INFORMATION PROCESSING METHOD

(71) Applicant: FUJITSU LIMITED, Kawasaki-shi (JP)

(72) Inventor: Kenji Hikichi, Kawasaki (JP)

(21) Appl. No.: 14/865,310

(22) Filed: Sep. 25, 2015

(30) Foreign Application Priority Data
Oct. 21, 2014 (JP) 2014-214837

(51) Int. Cl. H04L 12/721; H04L 12/801; H04L 12/725

(52) U.S. Cl. CPC H04L 45/66; H04L 45/30; H04L 47/33

(57) ABSTRACT

An information processing apparatus that sets, based on packet identification information that is common to packets included in a packet group that flows through a network including the communication devices performing relaying, and information about network function devices selected by the packet group, each of the network function devices being connected to the communication devices via a layer 2 network, performing a predetermined process for a packet and performing input and output of the packet by a same interface, one of interfaces of the communication devices as a forwarding destination of a packet input to the network function device in such a way that there is no overlap between the network function devices selected by the packet group and in such a way that overlap with another network function device selected by another packet group is allowed.

### CROSS-REFERENCE TO RELATED APPLICATION

This application is based upon and claims the benefit of priority of the prior Japanese Patent Application No. 2014-214837, filed on Oct. 21, 2014, the entire contents of which are incorporated herein by reference.

### FIELD

The present invention relates to an information processing apparatus, and an information processing method.

### BACKGROUND

With respect to a network that connects terminals such as PCs and mobile appliances at locations such as a head office and branch offices of a company, there are, in addition to connectivity, various prerequisites regarding security improvement, reduction of load on the server, efficient use of the network, and the like. To satisfy these prerequisites, communication devices having various functions, such as a firewall function, a cache function, and a bandwidth control function, are installed along the forwarding path between the terminals. Here, devices having such functions are collectively referred to as NF(s) (Network Function(s)).

As one technique for steering a flow between locations through an NF that provides the desired function, there is Service Chaining. Service Chaining is a technique for setting, in communication devices and NFs, the forwarding destination of a flow between locations so that the flow passes through NFs in an order determined in advance by a policy. Additionally, a flow is a group of packets having the same value as the information in the headers of the packets, such as destination and source IP addresses, a protocol type, and destination and source port numbers.

### Non Patent Document

[Non Patent document 1] “Policy-Based Routing (PBR)”, [online], Mar. 25, 2013, Cisco Systems, Inc., [retrieved on Oct. 3, 2014], Internet (http://www.cisco.com/cisco/web/support/JP/docs/SW/Campus LANSWT-CoreDistribution/CAT6500SWT/CG/001/policy_based_routing_pbr.html)
[Non Patent document 2] “CSS Load Balancing Using One Interface Configuration Example”, [online], May 1, 2003, Cisco Systems, Inc., [retrieved on Oct. 3, 2014], Internet (http://www.cisco.com/cisco/web/support/JP/100/1007/10071 22_one_armed_bandit-j.html)

However, with Service Chaining, if a complex function such as flow identification is provided to the NF as one of packet forwarding functions, the load regarding the forwarding function is increased, and available functions may possibly be limited. Accordingly, to use various functions, the packet forwarding function of the NF is desirably made simple.

If the packet forwarding function of the NF is simply to forward all the input packets to the same forwarding destination, Service Chaining may be achieved by using one-armed connection, for example. One-armed connection is a technique for achieving packet forwarding by one-on-one connection between an interface of a relay device such as a router and an interface of the NF.

FIG. 1 is a diagram illustrating an example of a configuration of Service Chaining using one-armed connection. In FIG. 1, an NF #1, an NF #2, an NF #3, an NF #4, and an NF #5 are each connected to an interface of a router A or a router B in a one-armed manner. The routers A and B are connected to each other through an infrastructure L2NW (layer 2 network). Terminals #1 to #4 to be the sources and destinations of packets are connected to the infrastructure L2NW via edge routers.

By connecting the NF to the IF (interface) of a router in a one-armed manner, Service Chaining may be achieved even in a case where the NF has a simple forwarding function of forwarding all the input packets to the same forwarding destination. However, in the case of using one-armed connection, since the NFs and the routers are connected one-on-one, the same number of interfaces of routers as the number of NFs is prepared. Since the unit price of the interface of the router is high, if the NFs are increased, the overall cost of communication is increased.

### SUMMARY

One aspect of the present invention is an information processing apparatus including a storage unit that stores packet identification information that is common to packets included in a packet group that flows through a network including communication devices performing relaying, and information about network function devices selected by the packet group, each of the network function devices being connected to the communication devices via a layer 2 network, performing a predetermined process for a packet and performing input and output of the packet by a same interface; a setting unit that sets, based on the information stored in the storage unit, one of interfaces of the communication devices as a forwarding destination of a packet input to each of the network function devices in such a way that there is no overlap between the network function devices selected by the packet group and in such a way that overlap with another network function device selected by another packet group is allowed; and a notification unit that notifies each of the network function devices selected by the packet group of the interface of a communication device set as the forwarding destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of Service Chaining using one-armed connection;

FIG. 2 is a diagram illustrating an example of a system configuration of a communication network system according to a first embodiment;

FIG. 3 is a diagram illustrating an example of a hardware configuration of a control device;

FIG. 4 is a diagram illustrating an example of a functional configuration of the control device;

FIG. 5 is a diagram illustrating an example of SC information;

FIG. 6 is a diagram illustrating an example of router IF information;

FIG. 7 is a diagram illustrating an example of router infrastructure connection information;

FIG. 8 is a diagram illustrating an example of node connection information;

FIG. 9 is an example of a flow chart of a first example of an NF forwarding destination determination process by an NF forwarding destination determination unit;

FIG. 10 is a diagram illustrating an example of NF traffic amount information;

FIG. 11 is a diagram illustrating an example of router IF bandwidth information;

FIG. 12 is an example of a flow chart of a second example of the NF forwarding destination determination process by the NF forwarding destination determination unit;

FIG. 13 is a diagram illustrating an example of node connection information as an execution result of the second example of the NF forwarding destination determination process illustrated in FIG. 12;

FIG. 14 is a diagram illustrating an example of NF set sequence number information;

FIG. 15 is an example of a flow chart of a third example of the NF forwarding destination determination process by the NF forwarding destination determination unit;

FIG. 16 is an example of the node connection information as an execution result of the third example of the NF forwarding destination determination process;

FIG. 17 is an example of a flow chart of a router forwarding destination determination process by a router forwarding destination determination unit;

FIG. 18 is an example of a flow chart of a routing table creation process;

FIG. 19 is an example of a routing table of a router obtained by a router forwarding determination process based on the node connection information in FIG. 8;

FIG. 20 is a diagram illustrating an example of a system configuration of a communication network system according to a second embodiment;

FIG. 21 is an example of router IF information according to the second embodiment;

FIG. 22 is an example of an initial state of node connection information according to the second embodiment; and

FIG. 23 is an example of a flow chart of a first example of an NF forwarding destination determination process according to the second embodiment.

### DESCRIPTION OF EMBODIMENT

Hereinafter, embodiments of the present invention will be described with reference to the drawings. Configurations of the embodiments below are merely exemplary, and the present invention is not limited to the configurations of the embodiments.

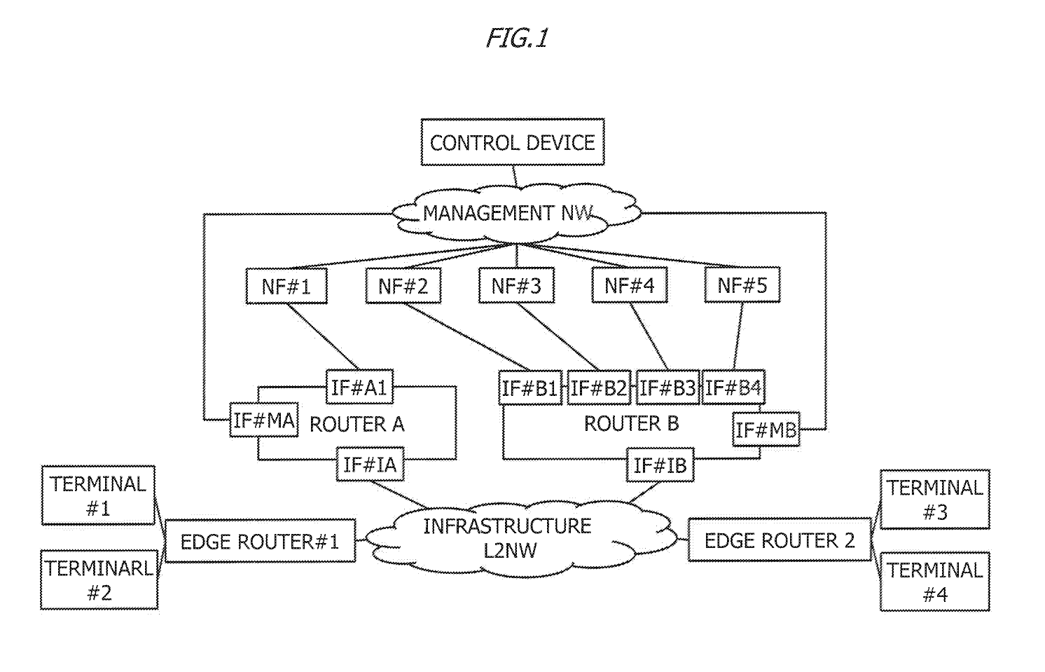

It is called “Service Chain”, abbreviated as SC, that a plurality of NFs is connected in a specified passing order. In FIG. 1, in the case of an SC passing through an NF #4 and NF #5, for example, when focusing on a router B, the passing order of a packet is as follows.

(infrastructure L2NW)->IF #IB->IF #B3->NF #4->IF #B3->IF #B4->NF #5->IF #B4->IF #IB->(infrastructure L2NW)

In this passing order of packets, the router B receives packets having the same destination IP address at the IF #IB, the IF #B3, and the IF #B4.

Normally, a router determines the output interface of a packet according to the destination IP address of the packet. However, in a network using one-armed connection as illustrated in FIG. 1, the router B is to receive packets having the same destination IP address at a plurality of interfaces, and packets are not distinguished from one another simply by the destination IP address.

Accordingly, in the example illustrated in FIG. 1, the router performs policy-based routing (PBR) of identifying a packet using, in addition to the destination IP address, a reception interface, and determining an output destination. The router B may thus perform routing of outputting an packet of the SC from the IF #B3 in the case of receiving the same packet at the IF #IB of the router B, and of outputting the packet of the SC from the IF #B4 in the case of receiving the same packet at the IF #B3 of the router B, and of outputting the packet of the SC from the IF #IB in the case of receiving the same at the IF #B4 of the router B. That is, SC may be achieved also in the case where an NF has a simple packet forwarding function of outputting an input packet from the same interface as the input interface, by the routers A and B performing PBR and each router and each NF being connected in a one-armed manner.

### First Embodiment

Hereinafter, an NF and a terminal will be referred to as node(s). A router is a relay device, and is thus distinguished from the NF and the terminal in the first embodiment, and is not referred to as a node.

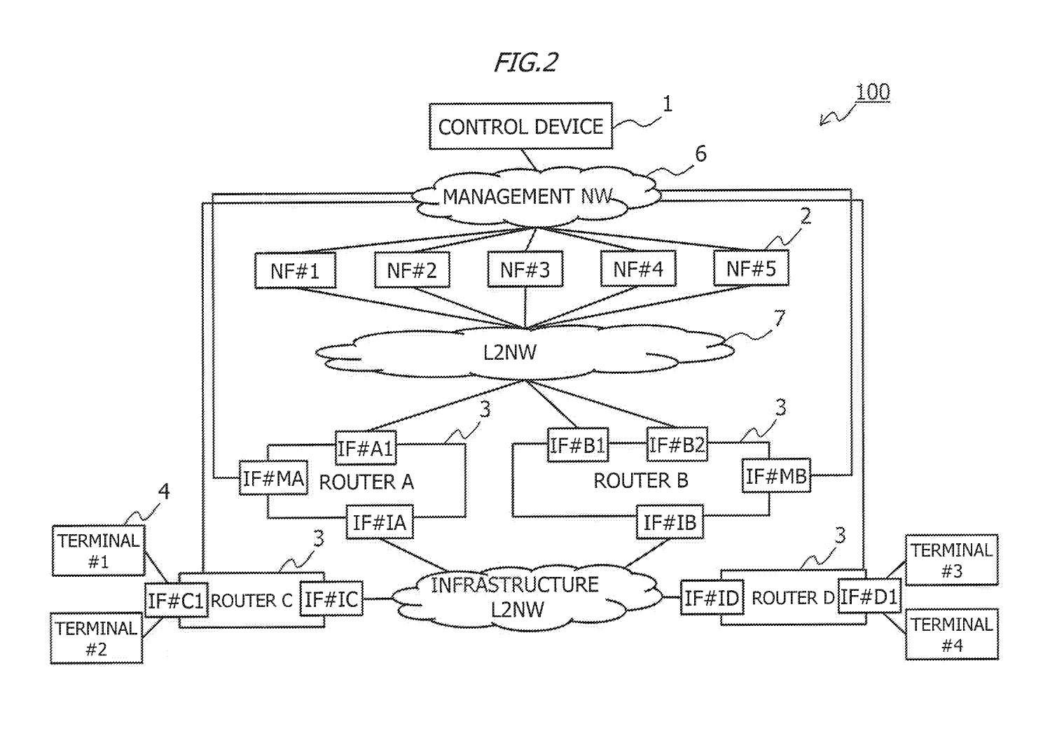

FIG. 2 is a diagram illustrating an example of a system configuration of a communication network system 100 according to the first embodiment. The communication network system 100 includes a control device 1, NFs #1 to #5, routers A to D, and terminals #1 to #4. In the following, in the case of not distinguishing among the NFs, the routers, and the terminals, they are expressed as the NF(s) 2, the router(s) 3, and the terminal(s) 4, respectively.

The routers 3 are connected to one another via the infrastructure L2NW. The infrastructure L2NW is a network including a plurality of L2 switches, for example. The routers A and B are routers installed at a station or a data center of a communication carrier, for example. The routers C and D are edge routers arranged at the boundary of a management range between a user and the communication carrier, for example.

Each NF 2 connects to the router A or B via the L2NW 7. Each NF 2 performs a process regarding firewall, security, a VPN (Virtual Private Network), load balancing, bandwidth control or the like to an input packet input via the L2NW 7. More specifically, in the case where the NF 2 is firewall, the NF 2 discards the packet if the value of the header of the input packet matches a predetermined value. Also, for example, in the case where the NF 2 is a bandwidth control device, the NF 2 adjusts the transmission interval of input packets. The L2NW 7 is an Ethernet (registered trademark) network, for example.

In the first embodiment, the NFs 2 are each assumed to be a low-performance device not having a function of identifying a packet, and having a forwarding function of forwarding input packets to the same forwarding destination. Also, the number of SCs to be handled by one NF 2 is assumed to be one.

The control device 1 connects to each NF 2 and each router 3 via a management NW 6. The control device 1 determines the forwarding destination of a packet of each NF 2 and the routing table of each router 3, and notifies each NF 2 of the forwarding destination of a packet and each router 3 of the routing table. The management NW 6 is an Ethernet network, for example.

In the first embodiment, the control device 1 assigns the interface of the router 3 to be the forwarding destination to each NF 2 in such a manner that there is no overlap between the NFs 2 in the same SC. On the other hand, the control device 1 allows overlap of the interface of the router 3 to be forwarding destination between the NFs 2 in different SCs.

Specifically, for example, in the case of a setting where an SC x passes through the NF #1, the NF #2, and the NF #3 and an SC y passes through the NF #4 and the NF #5, the determination process of the forwarding destination of each NF 2 by the control device 1 is as follows. The control device 1 sets the forwarding destination of each NF 2 in such a way that the interface of the router 3 to be the forwarding destination does not overlap among the NF #1, the NF #2, and the NF #3 in the SC x, and between the NF #4 and NF #5 in the SC y. On the other hand, the control device 1 allows the NF #4 in the SC y and one of the NFs #1 to #3 in the SC x to have the same interface as the forwarding destination, and the NF #5 in the SC y and one of the NFs #1 to #3 in the SC x to have the same interface as the forwarding destination.

Accordingly, the total number of interfaces of the routers 3 in the communication network system 100 does not have to be made the same as the number of NFs, and the number of interfaces of the routers 3 may be reduced. Additionally, the routers 3 have a function of identifying a packet, and thus are capable of distinguishing between packets in the SC x and the SC y and of processing packets of a plurality of SCs.

<Device Configuration>

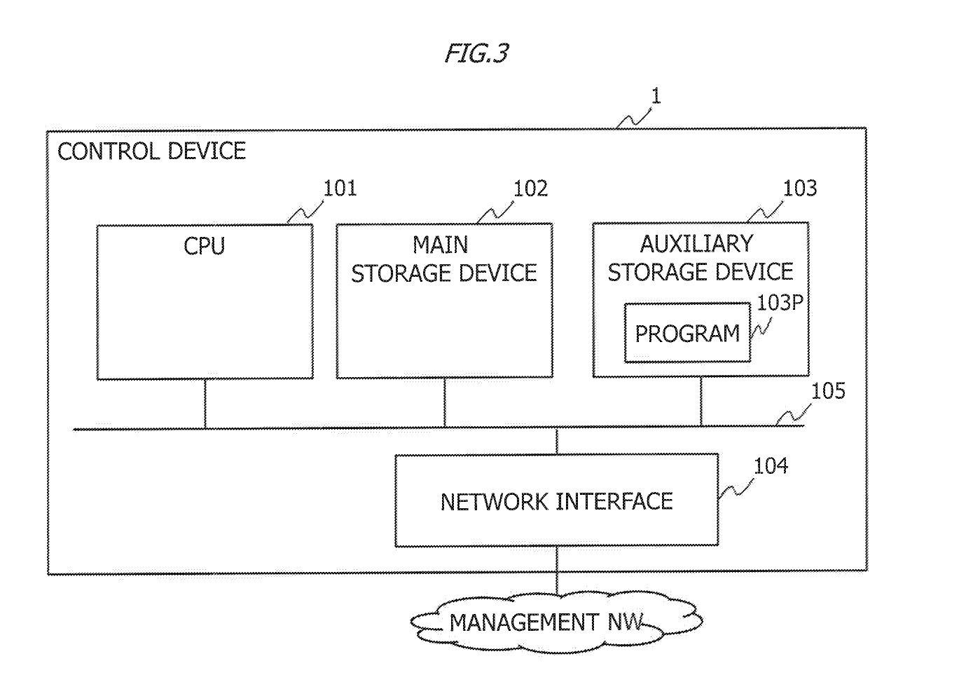

FIG. 3 is a diagram illustrating an example of a hardware configuration of the control device 1. The control device 1 is a dedicated computer such as a server, or a general-purpose computer such as a PC (Personal Computer), for example.

The control device 1 includes a CPU (Central Processing Unit) 101, a main storage device 102, an auxiliary storage device 103, and a network interface 104. Also, these are interconnected by a data bus 105.

The auxiliary storage device 103 stores an OS (Operating System), various programs, and data to be used by the CPU 101 at the time of execution of each program. The auxiliary storage device 103 is a non-volatile memory such as an EPROM (Erasable Programmable ROM), a flash memory, an SSD (Solid State Drive), or a hard disk drive, for example. The auxiliary storage device 103 stores a routing control program 103P, for example. The routing control program 103P is a program for determining the forwarding destination of the NF 2 and the routing table of the router.

The main storage device 102 is a storage device that provides the CPU 101 with a work area and a storage area for loading a program stored in the auxiliary storage device 103, or that is used as a buffer. The main storage device 102 is a semiconductor memory such as a RAM (Random Access Memory), for example.

The CPU 101 performs various processes by loading, into the main storage device 102, the OS and various application programs held in the auxiliary storage device 103, and executing the same. The number of CPUs 101 does not have to be one, and a plurality of CPUs 101 may also be provided.

The network interface 104 is an interface for performing input/output of information to/from a network. The network interface 104 may be an interface that is connected to a wired network, or an interface that is connected to a wireless network. For example, the network interface 104 is an NIC (Network Interface Card), a processing circuit for a wireless signal of a wireless LAN (Local Area Network) or the like. Data and the like received by the network interface 104 are output to the CPU 101.

Additionally, the hardware configuration of the control device 1 illustrated in FIG. 3 is merely an example, and omissions, replacements, and additions of structural elements as appropriate are possible according to the embodiment without being restricted to the above. For example, the control device 1 may include a removable recording medium drive device, and may execute a program recorded in a removable recording medium. The removable recording medium is a recording medium such as an SD card, a mini SD card, a micro SD card, an USB (Universal Serial Bus) flash memory, a CD (Compact Disc), a DVD (Digital Versatile Disc), a Blu-ray (registered trademark) Disc, or a flash memory card. The control device 1 may also include an input device such as a keyboard or a pointing device, and an output device such as a display, for example.

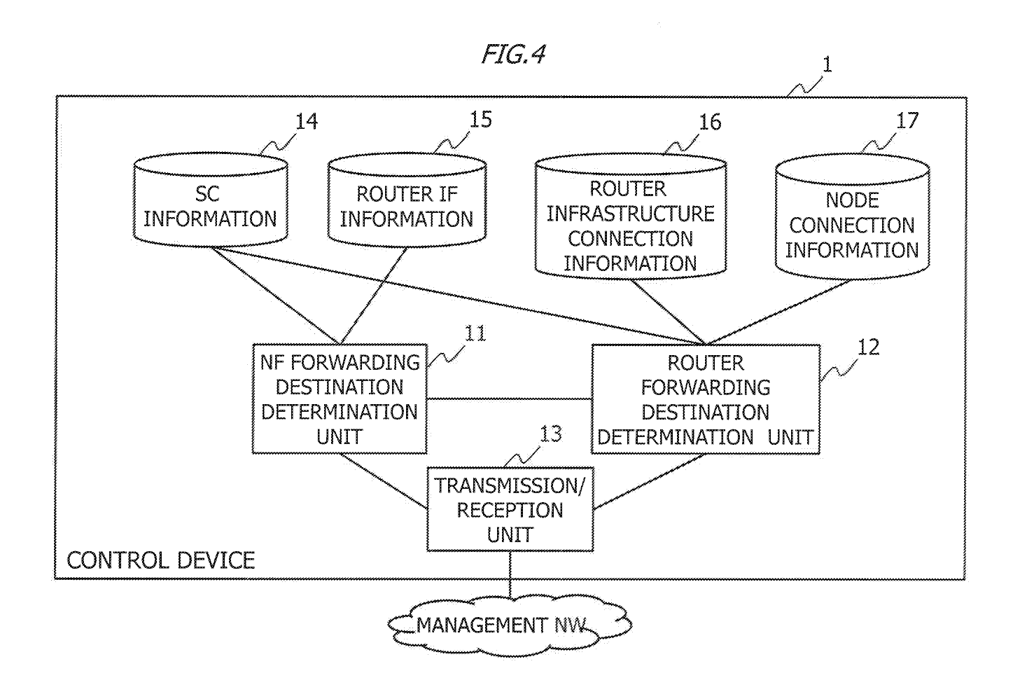

FIG. 4 is a diagram illustrating an example of a functional configuration of the control device 1. The functional configuration of the control device 1 illustrated in FIG. 4 is a functional configuration that is achieved by execution of the routing control program 103P by the CPU 101. However, this is not restrictive, and the functional configuration of the control device 1 illustrated in FIG. 4 may also be achieved by an electrical circuit such as an FPGA (Field-Programmable Gate Array), an ASIC (Application Specific Integrated Circuit), or the like.

The functional configuration of the control device 1 includes an NF forwarding destination determination unit 11, a router forwarding destination determination unit 12, and a transmission/reception unit 13. Also, the control device 1 holds, in the storage area of the auxiliary storage device 103, SC information 14, router IF information 15, router infrastructure connection information 16, and node connection information 17, by execution of the routing control program 103P by the CPU 101.

The NF forwarding destination determination unit 11 determines the interface of the router 3 to be the forwarding destination of each NF 2 by referring to the SC information 14, the router IF information 15, the router infrastructure connection information 16, and the node connection information 17, and by not allowing overlap between the NFs 2 in the same SC and allowing overlap between the NFs 2 in different SCs. Details of an NF forwarding destination determination process by the NF forwarding destination determination unit 11 will be given later.

The router forwarding destination determination unit 12 creates a routing table for each router 3 by referring to the SC information 14, the router infrastructure connection information 16, the node connection information 17, and the result of determination of the forwarding destination of each NF 2 by the NF forwarding destination determination unit 11. Details of a router forwarding destination determination process by the router forwarding destination determination unit 12 will be given later.

The transmission/reception unit 13 receives inputs of the forwarding destination of each NF 2 from the NF forwarding destination determination unit 11 and the routing table of each router 3 from the router forwarding destination determination unit 12. The transmission/reception unit 13 notifies the forwarding destination to the NF 2 and notifies the routing table to the router 3 via the management NW 6, the NF 2 and the router 3 being targets of setting.

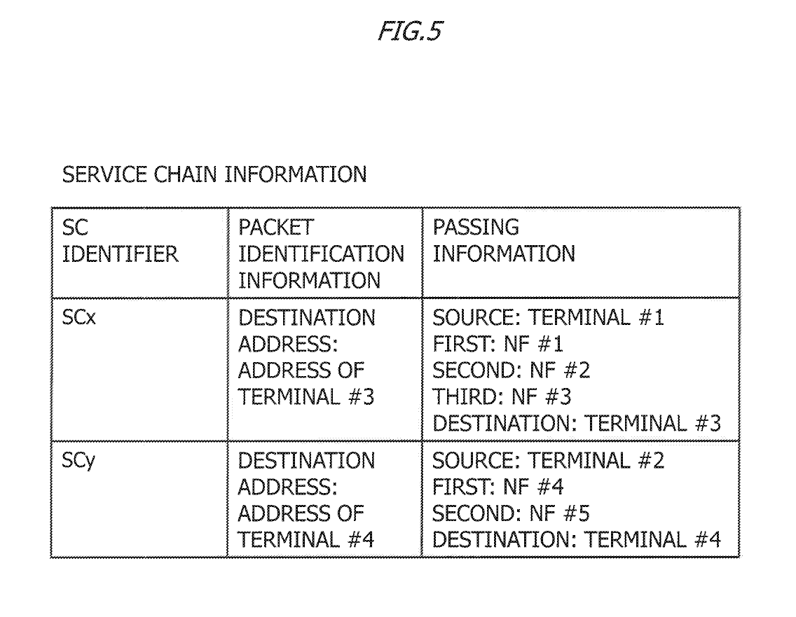

FIG. 5 is a diagram illustrating an example of the SC information 14. The SC information 14 holds information about the flow through the communication network system 100, a source device and a destination device of the flow, information about the NF 2 to be passed through, and the order of passing. Specifically, the entry of the SC information 14 includes a Service Chain identifier, packet identification information, and passing information.

The SC identifier is uniquely assigned to the SC by an administrator of the communication network system 100, for example. The packet identification information is information for identifying the flow, and in the first embodiment, a destination IP address is used as the packet identification information. Additionally, the packet identification information is not limited to the destination IP address. In the case where different SCs have the same destination IP address, and identification based on the destination IP address is not possible, a combination of pieces of information such as destination and source IP addresses, destination and source port numbers, the protocol type, and the like included in a packet header may be used.

The passing information is information about a source device and a destination device of a flow and the order of the NFs 2 to be passed through between the source device and the destination device. The source device, the destination device, and the NFs 2 included in the passing information are each registered by identification information, for example. The identification information of each device is any of an IP address and a device name, for example. The SC information 14 is input to the control device 1 by the administrator of the communication network system 100 directly or via a network, for example.

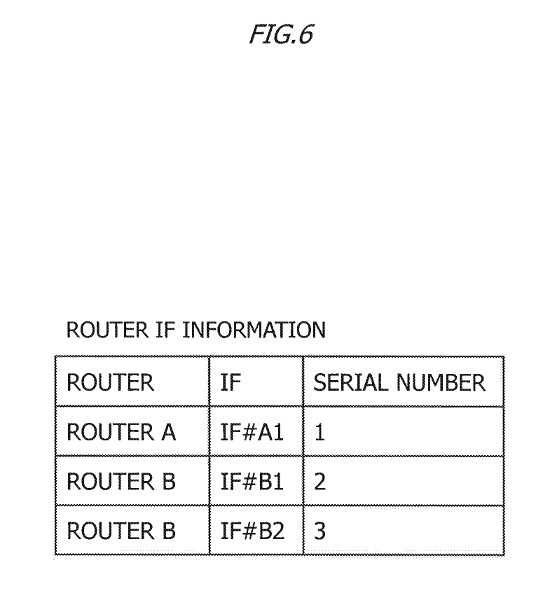

FIG. 6 is a diagram illustrating an example of the router IF information 15. The router IF information 15 holds information about an interface of each router 3 to be connected to the L2NW 7 on the side of the NF 2. Entry of the router IF information 15 includes items “router”, “interface” and “serial number”.

The item “router” includes the identification information of the router 3. The item “interface” includes the identification information of the interface in the router 3. The “serial number” is a sequential number assigned to the interface of every router 3, in the communication network system 100, connected to the L2NW 7 on the side of the NF 2.

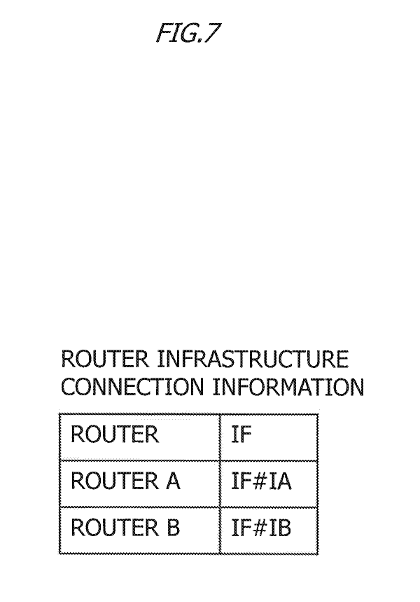

FIG. 7 is a diagram illustrating an example of the router infrastructure connection information 16. The router infrastructure connection information 16 holds information about an interface, of the router 3, connected to the infrastructure L2NW. Entry of the router infrastructure connection information 16 includes items “router” and “interface”.

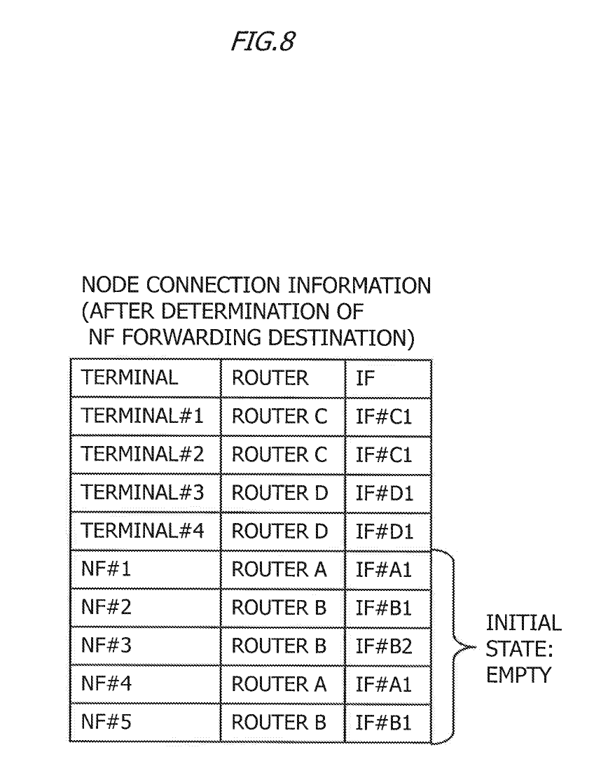

FIG. 8 is a diagram illustrating an example of the node connection information 17. The node connection information 17 holds information about interfaces of the routers 3 to which the terminals 4 and the NFs 2 in the communication network system 100 are to be connected. The interfaces of the routers 3 to which the terminals 4 are to be connected are determined in advance. On the other hand, the interfaces to which the NFs 2 are to be connected, that is, the interfaces of the routers 3 to be the forwarding destinations of the NFs 2, are not determined in the initial state, and thus, the items “router” and “interface” of the entry regarding the NFs 2 in the node connection information 17 are empty in the initial state.

When the interface of the router 3 to be the forwarding destination of each NF 2 is determined by the NF forwarding destination determination unit 11, pieces of information about the determined router and interface are stored in the items “router” and “interface” of the entry of the NF 2 in the node connection information 17.

Additionally, the data structures of the SC information 14, the router IF information 15, the router infrastructure connection information 16, and the node connection information 17 illustrated in FIGS. 5 to 8 are merely examples, and are not restrictive.

<Flow of Processing>

The determination process, by the NF forwarding destination determination unit 11, of the interface of the router 3 to be the forwarding destination of the NF 2 (the NF forwarding destination determination process) is not limited to a predetermined method as long as there is no overlap of the forwarding destination between the NFs 2 in the same SC. As the NF forwarding destination determination process by the NF forwarding destination determination unit 11, there are the following first to third examples.

(First Example of NF Forwarding Destination Determination Process)

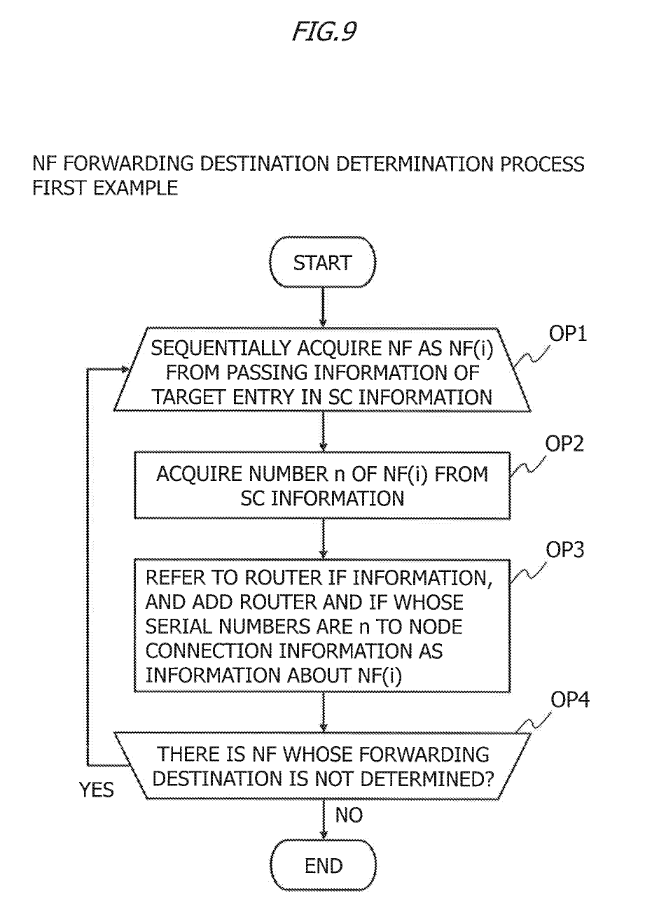

FIG. 9 is an example of a flow chart of the first example of the NF forwarding destination determination process by the NF forwarding destination determination unit 11. In the first example, the interface of the router 3 to be the forwarding destination of the NF 2 is determined by associating the passing order number of the NF 2 in the SC and the serial number of the interface of the router 3 in the communication network system 100. The process illustrated in FIG. 9 is started when the SC information 14 is updated by addition of a new SC or a change in an existing SC, for example. Also, the process illustrated in FIG. 9 is performed for a newly added SC or a changed SC among the SCs that are entered in the SC information 14. Additionally, the actual main doer of the NF forwarding destination determination process below is the CPU 101, but for the sake of convenience, description will be given taking the NF forwarding destination determination unit 11 as the main doer.

In OP 1, the NF forwarding destination determination unit 11 sequentially acquires, as an NF(i), an NF 2 in the passing information of the target entry in the SC information 14. Then, the process proceeds to OP 2.

In OP 2, the NF forwarding destination determination unit 11 acquires a passing order number n of the NF(i) from the passing information of the target entry in the SC information 14. However, the source device and the destination device are not to be included in the passing order. Next, the process proceeds to OP 3.

In OP 3, the NF forwarding destination determination unit 11 refers to the router IF information 15, and adds the router and the IF whose “serial number” in the router IF information 15 is “n” to the entry of the NF(i) in the node connection information 17. Additionally, the total number of interfaces of the routers 3 in the communication network system 100 is equal to or greater than the maximum number of the NFs 2 included in the SC, and thus the total number of the interfaces of the router 3 is equal to or greater than n. Then, the process proceeds to OP 4.

In OP 4, the NF forwarding destination determination unit 11 determines whether or not there is an NF 2 whose forwarding destination is not yet determined, in the passing information of the target entry in the SC information 14. In the case where there is an NF 2 whose forwarding destination is not determined (OP 4: YES), the process proceeds to OP 1, and the process is repeated from OP 1 for the next NF. In the case where the forwarding destination is determined for all the NFs 2 in the passing information of the target entry in the SC information 14 (OP 4: NO), the process illustrated in FIG. 9 is ended. In the case where an entry of an SC with an NF 2 whose forwarding destination is not determined still remains in the SC information 14, the process in FIG. 9 is performed again for the next entry of the SC.

For example, in the communication network system 100 illustrated in FIG. 2, the execution result of the first example of the NF forwarding destination determination process illustrated in FIG. 9 in a case where the SC information 14 illustrated in FIG. 5 and the router IF information 15 illustrated in FIG. 6 are set is the node connection information 17 illustrated in FIG. 8.

That is, the passing order of the NF #1 is the first in the entry of the SC x in the SC information 14, and thus an IF #A1 of the router A whose “serial number” is one in the router IF information 15 is determined as the forwarding destination of the NF #1. The passing order of the NF #2 is the second in the entry of the SC x in the SC information 14, and thus an IF #B1 of the router B whose “serial number” is two in the router IF information 15 is determined as the forwarding destination of the NF #2. The passing order of the NF #3 is the third in the entry of the SC x in the SC information 14, and thus an IF #B2 of the router B whose “serial number” is three in the router IF information 15 is determined as the forwarding destination of the NF #3.

The passing order of the NF #4 is the first in the entry of the SC y in the SC information 14, and thus the IF #A1 of the router A whose “serial number” is one in the router IF information 15 is determined as the forwarding destination of the NF #4. The passing order of the NF #5 is the second in the entry of the SC y in the SC information 14, and thus the IF #B1 of the router B whose “serial number” is two in the router IF information 15 is determined as the forwarding destination of the NF #5.

In the first example illustrated in FIG. 9, the passing order number of the NF 2 in the SC is in accordance with the serial number of the IF of the router 3 in the communication network system 100, but this is not restrictive. The number n of the NF(i) in the SC to be acquired in OP 2 may be numbered in any way as long as there is no overlap in the same SC.

(Second Example of NF Forwarding Destination Determination Process)

In the second example, the forwarding destination of an NF 2 is determined by referring to information about an NF 2 whose forwarding destination is already determined and another piece of information. In the second example, a case is described where bandwidth information is used as another piece of information.

For example, the NF forwarding destination determination unit 11 refers to an already determined forwarding destination of an NF 2, acquires a collection of interfaces which are not set as the forwarding destinations of the NFs 2 in the same SC, refers to the information about bandwidth, and determines an interface with the smallest available bandwidth in the collection as the forwarding destination of the next NF 2.

In the second example, the control device 1 holds, in the storage area of the auxiliary storage device 103, as bandwidth information, NF traffic amount information and router IF bandwidth information, in addition to the SC information 14, the router IF information 15, the router infrastructure connection information 16, and the node connection information 17.

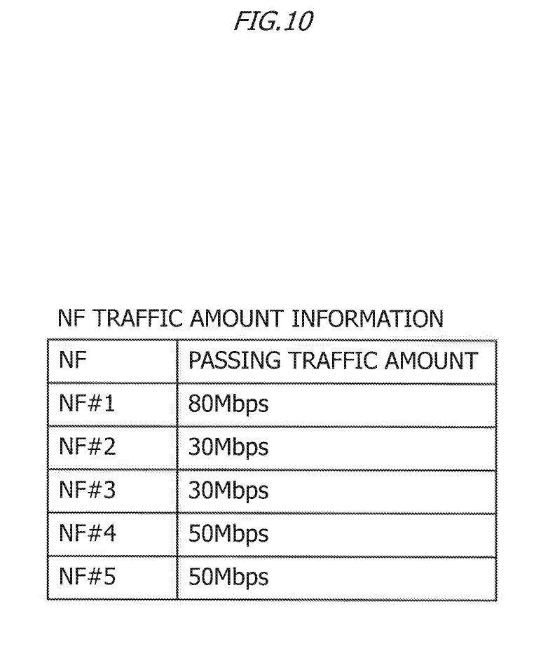

FIG. 10 is a diagram illustrating an example of the NF traffic amount information. The NF traffic amount information holds the passing traffic amount of each NF 2. As the passing traffic amount of each NF 2, a value determined while taking into account the traffic amount of the SC, the traffic reduction effect of the NF 2, and the like is input by the administrator of the communication network system 100, for example.

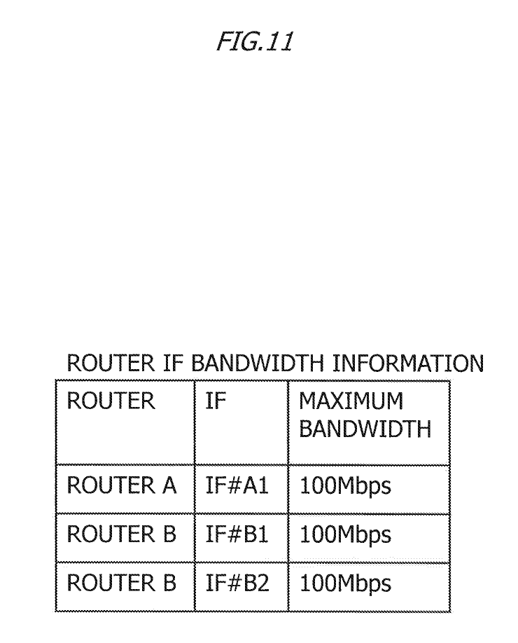

FIG. 11 is a diagram illustrating an example of the router IF bandwidth information. The router IF bandwidth information holds the maximum traffic amount that can be processed by the interface of each router 3. For example, the router IF bandwidth information may be input by the administrator of the communication network system 100, or may be collected from each router 3 by using a management protocol such as an SNMP (Simple Network Management Protocol).

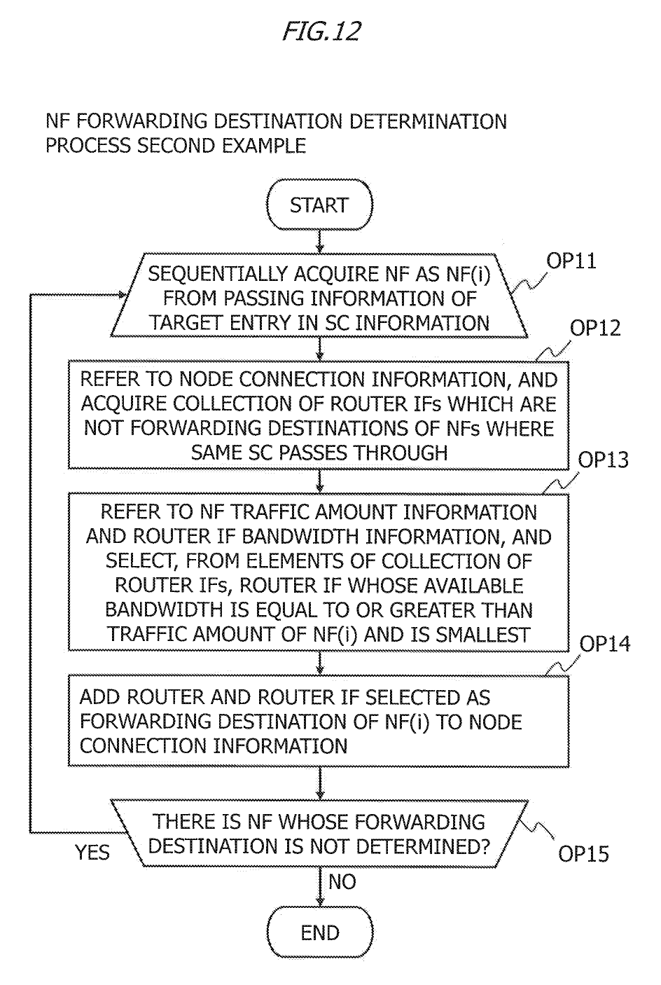

FIG. 12 is an example of a flow chart of a second example of the NF forwarding destination determination process by the NF forwarding destination determination unit 11. The process illustrated in FIG. 12 is started when the SC information 14 is updated by addition of a new SC or a change in an existing SC, for example. Also, the process illustrated in FIG. 12 is performed for a newly added SC or a changed SC among the SCs that are entered in the SC information 14.

In OP 11, the NF forwarding destination determination unit 11 sequentially acquires, as an NF(i), an NF 2 in the passing information of the target entry in the SC information 14. Then, the process proceeds to OP 12.

In OP 12, the NF forwarding destination determination unit 11 refers to the SC information 14, the router IF information 15, and the node connection information 17, and acquires a collection of interfaces of the routers 3 which are not set as the forwarding destinations of other NFs 2 in the same SC. Next, the process proceeds to OP 13.

In OP 13, the NF forwarding destination determination unit 11 refers to the NF traffic amount information and the router IF bandwidth information, and selects, from the collection of interfaces of the routers 3 acquired in OP 12, the interface of the router 3 whose available bandwidth is equal to or greater than the passing traffic amount of the NF(i) and is the smallest. Then, the process proceeds to OP 14.

In OP 14, the NF forwarding destination determination unit 11 adds the interface of the router 3 selected in OP 13 in the entry of the NF(i) in the node connection information 17. Next, the process proceeds to OP 15.

In OP 15, the NF forwarding destination determination unit 11 determines whether or not there is an NF 2 whose forwarding destination is not yet determined, in the passing information of the target entry in the SC information 14. In the case where there is an NF 2 whose forwarding destination is not determined (OP 15: YES), the process proceeds to OP 11, and the process is repeated from OP 11 for the next NF 2. In the case where the forwarding destination is determined for all the NFs 2 in the passing information of the target entry in the SC information 14 (OP 15: NO), the process illustrated in FIG. 12 is ended. In the case where an entry of an SC with an NF 2 whose forwarding destination is not determined still remains in the SC information 14, the process illustrated in FIG. 12 is performed for the next entry of the SC.

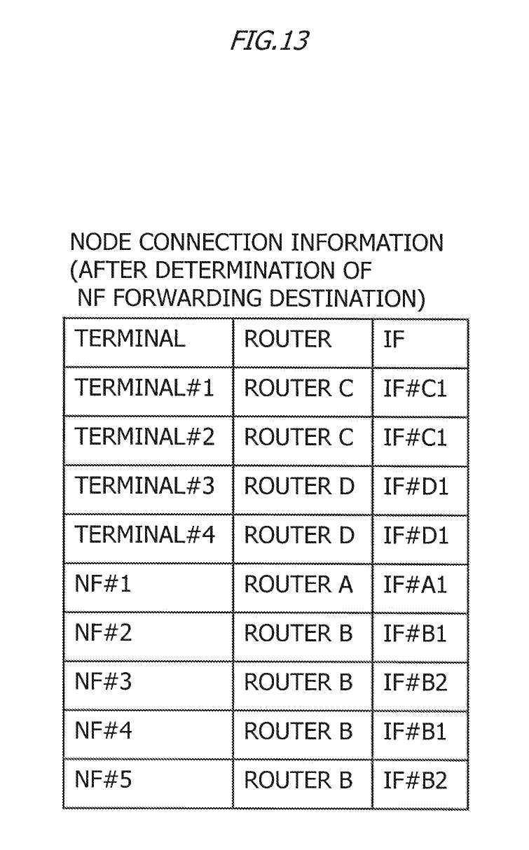

FIG. 13 is a diagram illustrating an example of the node connection information 17 as the execution result of the second example of the NF forwarding destination determination process illustrated in FIG. 12. The example illustrated in FIG. 13 assumes use of the SC information 14 illustrated in FIG. 5, the router IF information 15 illustrated in FIG. 6, the NF traffic amount information illustrated in FIG. 10, and the router IF bandwidth information illustrated in FIG. 11 in the communication network system 100 illustrated in FIG. 2.

For example, a case where the second example of the NF forwarding destination determination process is performed for the SC x will be first described. The passing traffic amount of the NF #1 is 80 Mbps (see FIG. 10). Any of the IF #A1 of the router A and the IF #B1 and the IF #B2 of the router B whose available bandwidths are 100 Mbps and which are not set as the forwarding destination of any of the NFs 2 in the SC x may be made the forwarding destination of the NF #1 (see FIG. 11). In the example illustrated in FIG. 13, the IF #A1 of the router A is selected as the forwarding destination of the NF #1.

Next, the passing traffic amount of the NF #2 is 30 Mbps (see FIG. 10). Since the IF #A1 of the router A is assigned to the NF #1 in the SC x, the IF #B1 and the IF #B2 of the router B whose available bandwidths are 100 Mbps and which are not set as the forwarding destination of any of the NFs 2 in the SC x may be made the forwarding destination of the NF #2 (see FIG. 11). In the example illustrated in FIG. 13, the IF #B1 of the router B is selected as the forwarding destination of the NF #2.

Next, since the IF #A1 of the router A is assigned to the NF #1 in the SC x, and the IF #B1 of the router B to the NF #2 in the SC x, the IF #B2 of the router B is assigned to the NF #3 in the SC x. The available bandwidth of the IF #2 of the router B is 100 Mbps and is equal to or greater than the passing traffic amount 30 Mbps of the NF #3, and is thus appropriate as the forwarding destination of the NF #3.

Next, a case where the second example of the NF forwarding destination determination process is performed for the SC y will be described. The passing traffic amount of the NF #4 is 50 Mbps (see FIG. 10). The available bandwidth of the IF #A1 of the router A is 20 Mbps. The available bandwidth of the IF #B1 of the router B is 70 Mbps. The available bandwidth of the IF #B2 of the router B is 70 Mbps. Accordingly, the IF #B1 and the IF #B2 of the router B whose available bandwidths are greater than the passing traffic amount of the NF #4 may be made the forwarding destination of the NF #4. In the example illustrated in FIG. 13, the IF #B1 of the router B is selected as the forwarding destination of the NF #4.

Next, the traffic amount of the NF #5 in the SC y is 50 Mbps (see FIG. 10). The available bandwidth of the IF #A1 of the router A is 20 Mbps and is not enough. The IF #B1 of the router B is set as the forwarding destination of the NF #4 in the same SC y. Accordingly, one that can be made the forwarding destination of the NF #5 in the SC y is the IF #B2 of the router B which is not set as the forwarding destination of the NF 2 in the same SC y and whose available bandwidth is 70 Mbps.

In the second example, by using the bandwidth information in the NF forwarding destination determination process, it is possible to prevent an SC with a traffic amount exceeding the traffic amount that can be processed from passing through the interface of each router 3.

Also, in the second example, the bandwidth of each interface may be efficiently used by setting the interface with the smallest bandwidth as the forwarding destination of the NF 2. For example, by assigning an interface from the one with the smallest available bandwidth as the forwarding destination of the NF 2 and filling in the bandwidths, an interface with a large available bandwidth may be kept aside. Accordingly, if an SC that desires a large bandwidth occurs in the future, this SC may be accommodated, and the possibility of setting of a new SC being rejected (blocked) may be reduced.

For example, a case of assigning one of three interfaces, each capable of processing maximum 100 Mbps, as the forwarding destination of each of the three NFs 2 having maximum bandwidths of 50 Mbps will be described. In the case of assigning each interface as the forwarding destination of each NF 2, the used bandwidths of the interfaces will be {50 Mbps, 50 Mbps, 50 Mbps}. If an NF 2 whose maximum bandwidth is 80 Mbps is then newly added, there is no interface that can be assigned as the forwarding destination of this new NF 2, and setting of an SC that passes through the new NF 2 will be rejected.

On the other hand, in the case where one of the three interfaces is assigned as the forwarding destinations of two NFs 2, and one of the two remaining interfaces is assigned as the forwarding destination of the one remaining NF 2, the used bandwidths of the interfaces will be {100 Mbps, 50 Mbps, 0 Mbps}. If an NF 2 whose maximum bandwidth is 80 Mbps is then newly added, this new NF 2 may have the interface whose used bandwidth is 0 Mbps as the forwarding destination, and an SC passing through the new NF 2 may be accommodated.

Also, as in the second example, by filling in the bandwidths by assigning interfaces, as the forwarding destinations of the NFs 2, from the interface with the smallest available bandwidth, there is a possibility that there will be an interface whose used bandwidth is 0 Mbps, that is, an interface which is not used. By cutting off power to an unused interface, power may be saved.

Additionally, the NF forwarding destination determination process may be performed by using information other than the bandwidth information. For example, information about the upper limit value of the number of SCs that can pass, for each interface of the router 3, may be used. In this case, the NF forwarding destination determination unit 11 counts the number of NFs 2 for which the interface of the router 3 is assigned as the forwarding destination, based on the node connection information 17, and determines the forwarding destination of the NF 2 in such a way that the count number does not exceed the upper limit value of each interface. Also, as information other than the bandwidth information, the priority assigned to each interface may be used. The priority is set in advance based on the performance of each interface, for example. In this case, the NF forwarding destination determination unit 11 assigns, as the forwarding destination of an NF 2, an interface with the highest priority among interfaces which are not assigned as the forwarding destinations of other NFs 2 in the SC passing through the NF 2.

In the second example, the NF forwarding destination determination process is performed by using information about an already determined forwarding destination of an NF 2 and another piece of information, and thus the forwarding destination of an NF 2 can be determined flexibly according to the state of the network.

(Third Example of NF Forwarding Destination Determination Process)

In a third example, the forwarding destination of each NF 2 is determined by uniquely assigning a number to each NF 2 in all the SCs in the communication network system 100, and associating the number of each NF 2 and the serial number of the interface of the router 3.

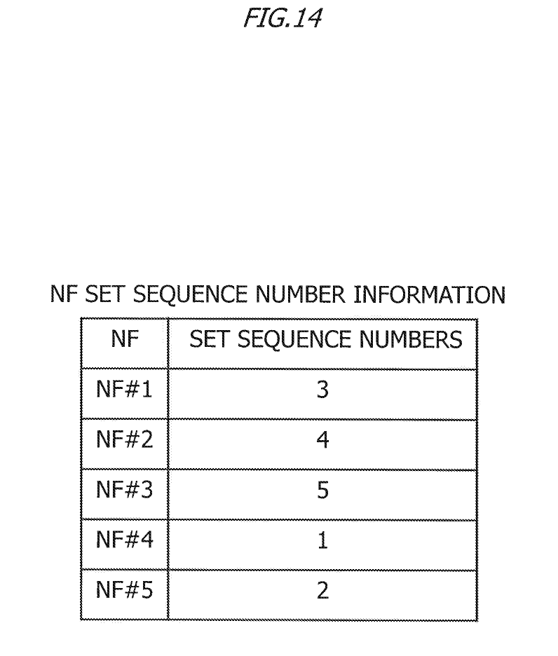

FIG. 14 is a diagram illustrating an example of NF set sequence number information. The NF set sequence number information is a set sequence number that is uniquely assigned to each of all the NFs 2 in the communication network system 100. The NF set sequence number information is created by the NF forwarding destination determination unit 11, and is stored in the storage area of the auxiliary storage device 103, for example. The NF forwarding destination determination unit 11 refers to the passing information in the SC information 14, and assigns the set sequence number to each NF 2 in the communication network system 100 in such a way that the NFs 2 in the same SC will have serial numbers in the order of passing.

In the example illustrated in FIG. 14, the set sequence numbers of the NF #1, the NF #2, and the NF #3 in the SC x are 3, 4, and 5, respectively. Also, the set sequence numbers of the NF #4 and the NF #5 in the SC y are 1 and 2, respectively. Accordingly, in the example illustrated in FIG. 14, the NFs 2 in the same SC are provided with set sequence numbers in such a way that the numbers are serial numbers in the passing order.

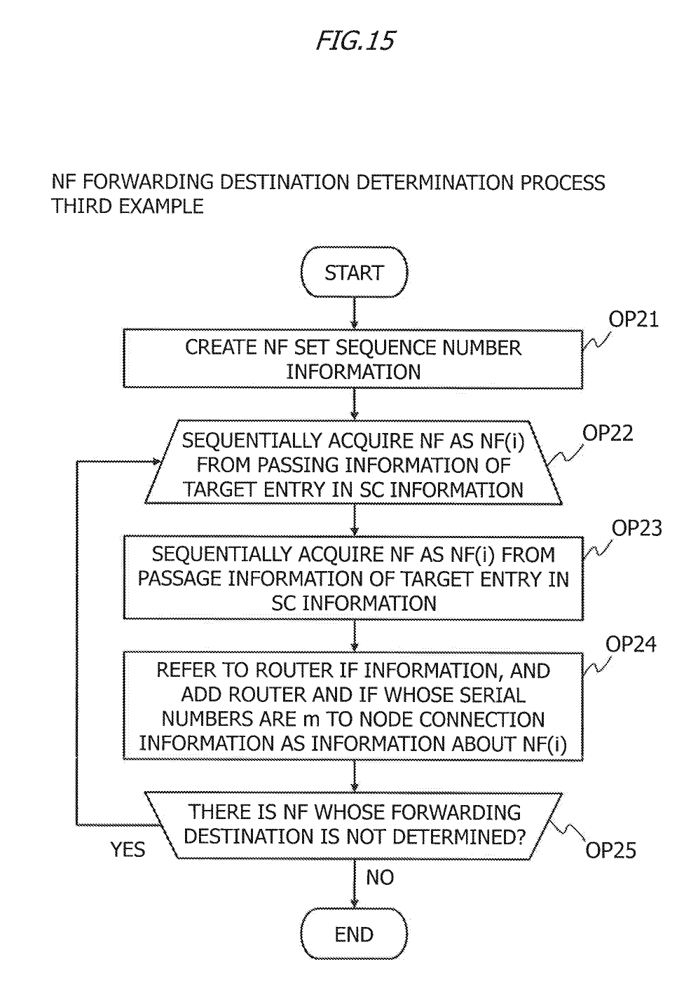

FIG. 15 is an example of a flow chart of the third example of the NF forwarding destination determination process by the NF forwarding destination determination unit 11. The process illustrated in FIG. 15 is started when the SC information 14 is updated by addition of a new SC or a change in an existing SC, for example. Also, the process illustrated in FIG. 15 is performed for a newly added SC or a changed SC among the SCs that are entered in the SC information 14.

In OP 21, the NF forwarding destination determination unit 11 creates the NF set sequence number information. In the case where an SC is newly added, a set sequence number is assigned to the NF 2 in the new SC from a number following the set sequence number that is already registered in the NF set sequence number information. Next, the process proceeds to OP 22.

In OP 22, the NF forwarding destination determination unit 11 sequentially acquires, as an NF(i), an NF 2 in the passing information of the target entry in the SC information 14. Then, the process proceeds to OP 23.

In OP 23, the NF forwarding destination determination unit 11 acquires a set sequence number n of the NF(i) from the NF set sequence number information, and acquires a value m that is obtained by adding one to the remainder that is obtained by dividing the set sequence number n by the total number of the interfaces of the routers 3 in the communication network system 100. Then, the process proceeds to OP 24.

In OP 24, the NF forwarding destination determination unit 11 refers to the router IF information 15, and enters the router and the IF whose “serial number” in the router IF information 15 is “m” in the entry of the NF(i) in the node connection information 17. Next, the process proceeds to OP 25.

In OP 25, the NF forwarding destination determination unit 11 determines whether or not there is an NF 2 whose forwarding destination is not yet determined, in the passing information of the target entry in the SC information 14. In the case where there is an NF 2 whose forwarding destination is not determined (OP 25: YES), the process proceeds to OP 22, and the process is repeated from OP 22 for the next NF 2. In the case where the forwarding destination is determined for all the NFs 2 in the passing information of the target entry in the SC information 14 (OP 25: NO), the process illustrated in FIG. 15 is ended. In the case where an entry of an SC with an NF 2 whose forwarding destination is not determined still remains in the SC information 14, the process in FIG. 15 is performed for the entry of the next SC.

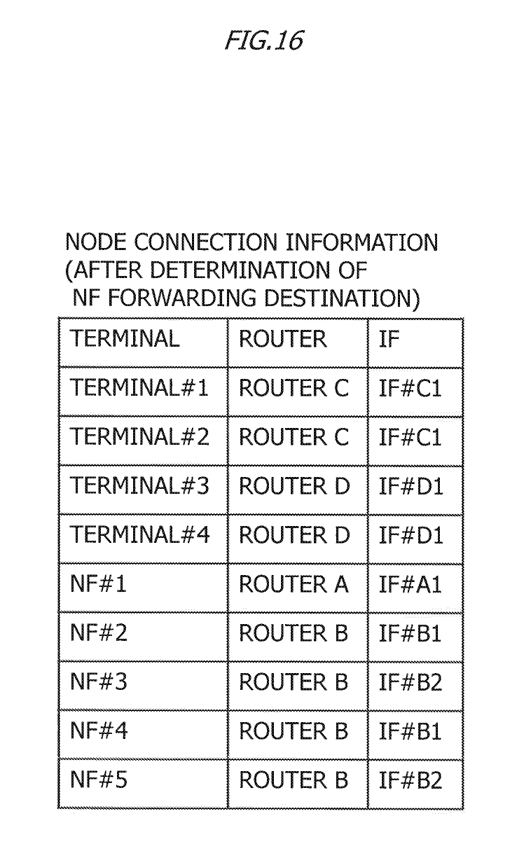

FIG. 16 is a diagram illustrating an example of the node connection information 17 as the execution result of the third example of the NF forwarding destination determination process. The example illustrated in FIG. 16 assumes use of the SC information 14 illustrated in FIG. 5, the router IF information 15 illustrated in FIG. 6, and the NF set sequence number information illustrated in FIG. 14 in the communication network system 100 illustrated in FIG. 2.

The set sequence number of the NF #1 in the NF set sequence number information is three, and thus the value m is one, m being obtained by adding one to the remainder obtained by dividing the set sequence number n by the total number, three, of the interfaces of the routers 3. Accordingly, the IF #A1 of the router A whose “serial number” in the router IF information 15 is one is determined as the forwarding destination of the NF #1. The set sequence number of the NF #2 in the NF set sequence number information is four, and thus the value m is two, m being obtained by adding one to the remainder obtained by dividing the set sequence number n by the total number, three, of the interfaces of the routers 3. Accordingly, the IF #B1 of the router B whose “serial number” in the router IF information 15 is two is determined as the forwarding destination of the NF #2. The set sequence number of the NF #3 in the NF set sequence number information is five, and thus the value m is three, m being obtained by adding one to the remainder obtained by dividing the set sequence number n by the total number, three, of the interfaces of the routers 3. Accordingly, the IF #B2 of the router B whose “serial number” in the router IF information 15 is three is determined as the forwarding destination of the NF #3.

The set sequence number of the NF #4 in the NF set sequence number information is one, and thus the value m is two, m being obtained by adding one to the remainder obtained by dividing the set sequence number n by the total number, three, of the interfaces of the routers 3. Accordingly, the IF #B1 of the router B whose “serial number” in the router IF information 15 is two is determined as the forwarding destination of the NF #4. The set sequence number of the NF #5 in the NF set sequence number information is two, and thus the value m is three, m being obtained by adding one to the remainder obtained by dividing the set sequence number n by the total number, three, of the interfaces of the routers 3. Accordingly, the IF #B2 of the router B whose “serial number” in the router IF information 15 is three is determined as the forwarding destination of the NF #5.

Each NF 2 is notified, by the transmission/reception unit 13, of the interface of the router 3 as the forwarding destination which is obtained as the execution result of the NF forwarding destination determination process. More specifically, the interface of the router 3 that is stored in the entry of the target NF 2 in the node connection information 17 is notified to the target NF 2. For example, in the case of the example illustrated in FIG. 16, the NF #1 is notified of the IF #A1 of the router A as the forwarding destination.

(Router Forwarding Destination Determination Process)

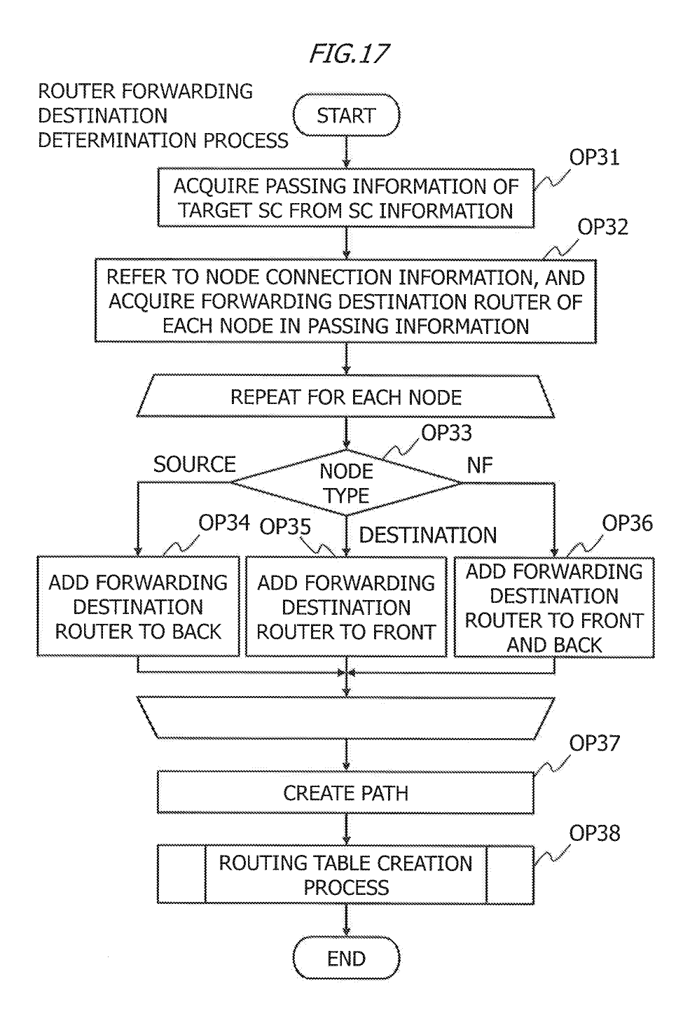

FIG. 17 is a diagram illustrating an example of a flow chart of a router forwarding destination determination process by the router forwarding destination determination unit 12. The router forwarding destination determination process is a process for determining the forwarding destination of the packet of each router 3, that is, a process for creating a routing table of each router 3. The process illustrated in FIG. 17 is started when the node connection information 17 is created or updated by the NF forwarding destination determination unit 11. Also, the process illustrated in FIG. 17 is performed for each SC included in the SC information 14. The actual main doer of the process illustrated in FIG. 17 is the CPU 101, but for the sake of convenience, description will be given taking the router forwarding destination determination unit 12 as the main doer.

In OP 31, the router forwarding destination determination unit 12 acquires the passing information of the target SC from the SC information 14. For example, in the case where the target SC is the SC x, the router forwarding destination determination unit 12 acquires, as the passing information in the SC information 14, terminal #1->NF #1->NF #2->NF #3->terminal #3. Then, the process proceeds to OP 32.

In OP 32, the router forwarding destination determination unit 12 refers to the node connection information 17, and acquires the forwarding destination router of each node in the passing information. For example, if the node connection information 17 is the one illustrated in FIG. 8, the forwarding destination router of each node in the SC x is as below. Then, the process proceeds to OP 33.

(Example of Node and Forwarding Destination Router)

Terminal #1: Router C

NF #1: Router A

NF #2: Router B

NF #3: Router B

Terminal 3: Router D

The process from OP 33 is repeated for each node in the target SC. In OP 33, the router forwarding destination determination unit 12 determines which of the source device, the destination device, and the NF the type of the target node is. In the case where the target node is the source device, the process proceeds to OP 34. In the case where the target node is the destination device, the process proceeds to OP 35. In the case where the target node is the NF, the process proceeds to OP 36.

In OP 34, since the target node is the source device, the router forwarding destination determination unit 12 attaches the forwarding destination router to behind the target node. In OP 35, since the target node is the destination device, the router forwarding destination determination unit 12 attaches the forwarding destination router to before the target node. In OP 36, since the target node is the NF 2, the router forwarding destination determination unit 12 attaches the forwarding destination router to before and behind the target node. Examples of the execution results of OP 33 to OP 36 for the nodes included in the SC x are as below. After the processes of OP 34 to OP 36, the process proceeds to OP 37.

(Execution Results of OP 33 to OP 36 for SC x)

Terminal #1->Router C

Router A->NF #1->Router A

Router B->NF #2->Router B

Router B->NF #3->Router B

Router D->Terminal 3

In OP 37, the router forwarding destination determination unit 12 connects the execution results of OP 34 to OP 36 in the order of the passing information, and creates a path including the routers 3 in the target SC. At this time, if there is a succession of the same routers 3, these are integrated into one. The path including the routers 3 in the SC x is as below. Since there is a succession of the routers B between the NF #2 and the NF #3, the routers B are integrated into one. Then, the process proceeds to OP 38.

(Path Including Routers 3 in SC x)

Terminal #1->Router C->Router A->NF #1->Router A->Router B->NF #2->Router B->NF #3->Router B->Router D->Terminal #3

In OP 38, the router forwarding destination determination unit 12 performs a routing table creation process. A routing table creation process is a process of creating an entry for the routing table of each router from the created path including the router. Details of the routing table creating process will be given later. When the routing table creation process is ended, the process illustrated in FIG. 17 is ended. The entry created for the routing table is output to the transmission/reception unit 13 from the router forwarding destination determination unit 12, and is notified to each router 3 by the transmission/reception unit 13.

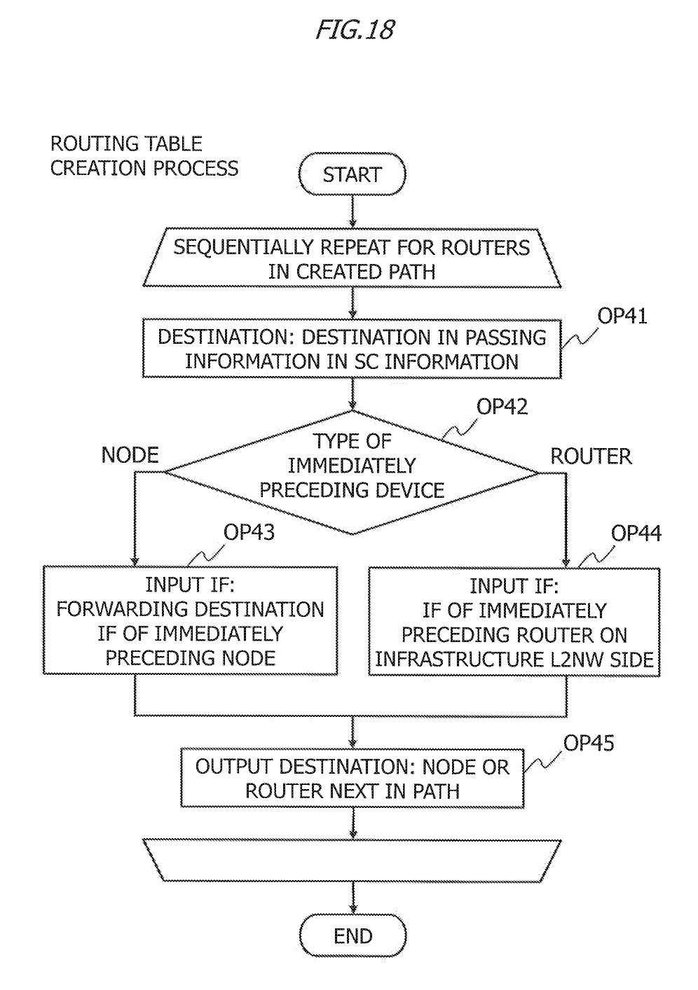

FIG. 18 is an example of a flow chart of the routing table creation process. The routing table creation process is a part of the router forwarding destination creation process. The routing table creation process is performed again every time a router 3 appears in the path which is created in OP 37 and which includes the routers 3 in the target SC. In the description of FIG. 18, the router 3, in the path including the routers 3 in the target SC, for whose routing table an entry is to be created, will be referred to as a “target router”. Also, the entry of the routing table of the router 3 includes items “destination address”, “input interface”, and “output destination” (details will be given later).

In OP 41, the router forwarding destination determination unit 12 takes the IP address of the destination device in the passing information in the SC information 14 as the “destination address” in the entry of the routing table of the target router. Then, the process proceeds to OP 42.

OP 42 to OP 44 are processes for determining the “input interface” in the entry of the routing table of the target router. In OP 42, the router forwarding destination determination unit 12 determines, with respect to the created path, whether the type of the device immediately before the target router 3 is a node or a router. In the case where, in the created path, the type of the device immediately before the target router 3 is a node, the process proceeds to OP 43. In the case where, in the created path, the type of the device immediately before the target router 3 is a router, the process proceeds to OP 44.

In OP 43, since, in the created path, the type of the device immediately before the target router 3 is a node, the router forwarding destination determination unit 12 takes the forwarding destination interface of the immediately preceding node as the “input interface” in the entry of the routing table of the target router 3. The forwarding destination interface of the immediately preceding node is acquired from the node connection information 17. Next, the process proceeds to OP 45.

In OP 44, since, in the created path, the type of the device immediately before the target router 3 is a router, the router forwarding destination determination unit 12 takes the interface of the immediately preceding router 3, on the side of the infrastructure L2NW, as the “input interface” in the entry of the routing table of the target router 3. The interface of the router 3, on the side of the infrastructure L2NW, is acquired from the router infrastructure connection information 16. Then, the process proceeds to OP 45.

In OP 45, the router forwarding destination determination unit 12 sets the “output destination” in the entry of the routing table of the target router 3 to the node or the router subsequent to the target router 3 in the created path. When the process of OP 45 is ended, the router 3 appearing immediately after the target router is made the new target router, and the process is performed again from OP 41. When an entry for the routing table is created for all the routers in the created path, the process illustrated in FIG. 18 is ended.

For example, in the path including the routers 3 in the SC x described above, the routers 3 appear seven times, and thus the routing table creation process is performed seven times. For example, in the entry in the routing table of the router C appearing first on the path, the “destination address” is the terminal #3, the “input interface” is the IF #C1 of the router C which is the forwarding destination of the terminal #1 (the immediately preceding node) (see the node connection information in FIG. 8), and the “output destination” is the router A.

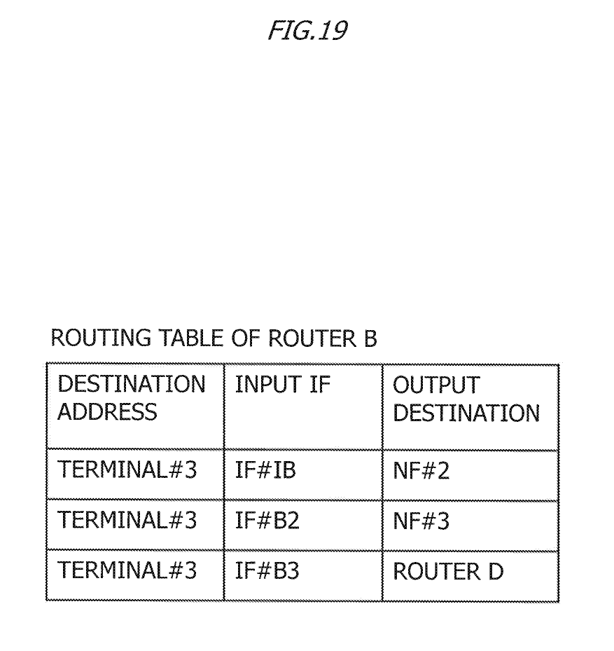

FIG. 19 is an example of the routing table of the router 3 obtained by the router forwarding destination determination process that is based on the node connection information 17 in FIG. 8. FIG. 19 illustrates the routing table for the router B in the case where the router forwarding destination determination process is performed for the SC x.

An IP address is stored in the “destination address”. Identification information of the interface of the router 3 possessing this routing table is stored in the “input interface”. An IP address, a MAC address or the like of the device to be the next hop is stored in the “output destination”.

If the destination IP address of an input packet and the input interface match the “destination address” and the “input interface” of one of the entries of the routing table, the router 3 outputs the input packet to the “output destination” of the entry. That is, the router 3 performs PBR.

However, the data structure of the routing table is not limited to that illustrated in FIG. 19. Other than the destination IP address, values in the packet header such as the source IP address, the destination and source port numbers, the protocol type and the like may be used.

### Operation and Effects of First Embodiment

In the present embodiment, the NFs 2 and the routers 3 are connected via the L2NW, and overlap of interfaces of the routers 3 to be the forwarding destinations of the NFs 2 is allowed between different SCs, and thus the number of interfaces used for connecting the NFs 2 may be made small. For example, in the communication network system 100 illustrated in FIG. 2, the number of interfaces of the routers 3 for five NFs 2 may be reduced to three, as indicated by the node connection information 17 in FIGS. 8, 13, and 16.

Also, in the first embodiment, since the control device 1 determines an interface of one router 3 as the forwarding destination of an NF 2, the NF 2 may be installed with a simple forwarding function of forwarding an input packet to the determined forwarding destination. That is, according to the first embodiment, an SC may be achieved even when an NF 2 with a simple forwarding function is used.

### Second Embodiment

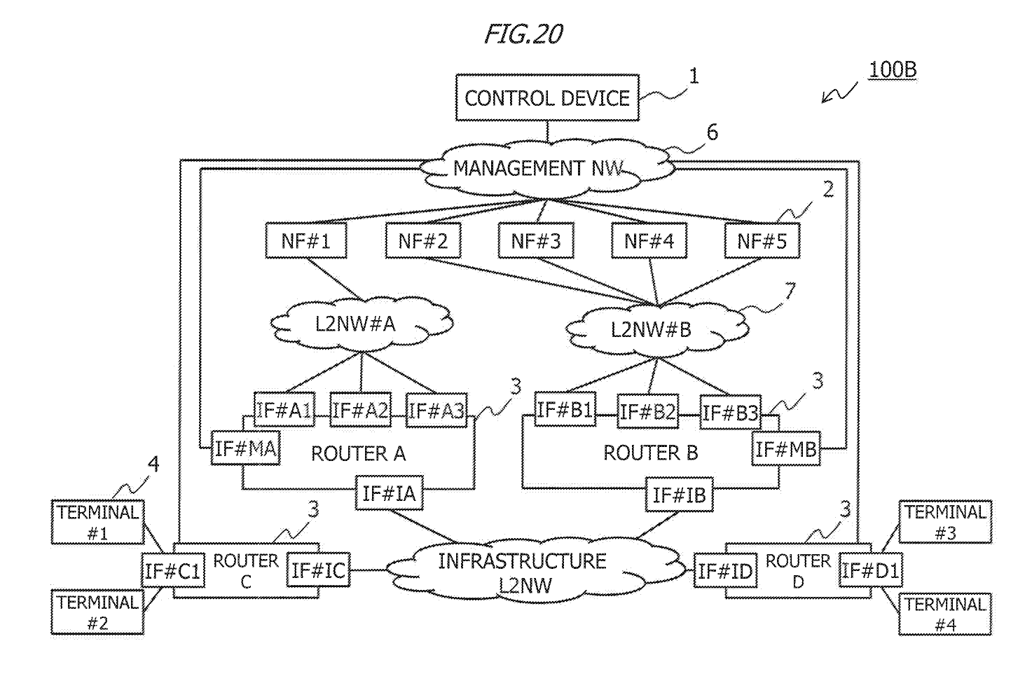

FIG. 20 is an example of a system configuration of a communication network system 100B according to a second embodiment. In the first embodiment, all the NFs 2 and all the routers 3 are connected via a same L2NW. On the other hand, in the second embodiment, for example, a router A and a router B are located at geographically separated locations, and the L2NW connecting the router A and the NF 2 and the L2NW connecting the router B and the NF 2 are different. In the second embodiment, a description overlapping the one given in the first embodiment will be omitted.

In the second embodiment, the hardware configuration and the functional configuration of the control device 1 are the same as those in the first embodiment. However, the ways in which pieces of information are held in the router IF information 15 and the node connection information 17 are different.

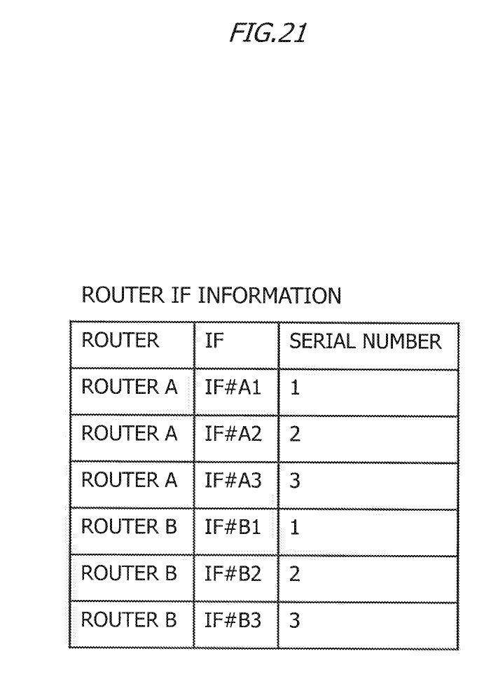

FIG. 21 is an example of the router IF information 15 according to the second embodiment. In the second embodiment, serial numbers for a router 3 are assigned to the interfaces of the router 3, instead of serial numbers for the entire communication network system 100B.

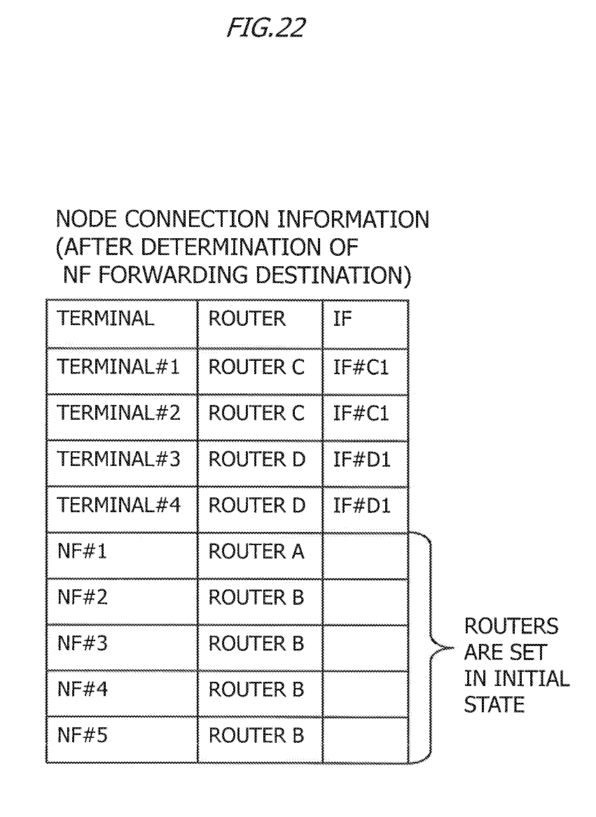

FIG. 22 is an example of the initial state of the node connection information 17 according to the second embodiment. In the second embodiment, the router to which an NF 2 is to connect is determined in advance, and in the node connection information 17, the item of “router” in the entry of the NF 2 is set in the initial state. This is because it is more efficient to connect to the router 3 which is geographically close to the NF 2.

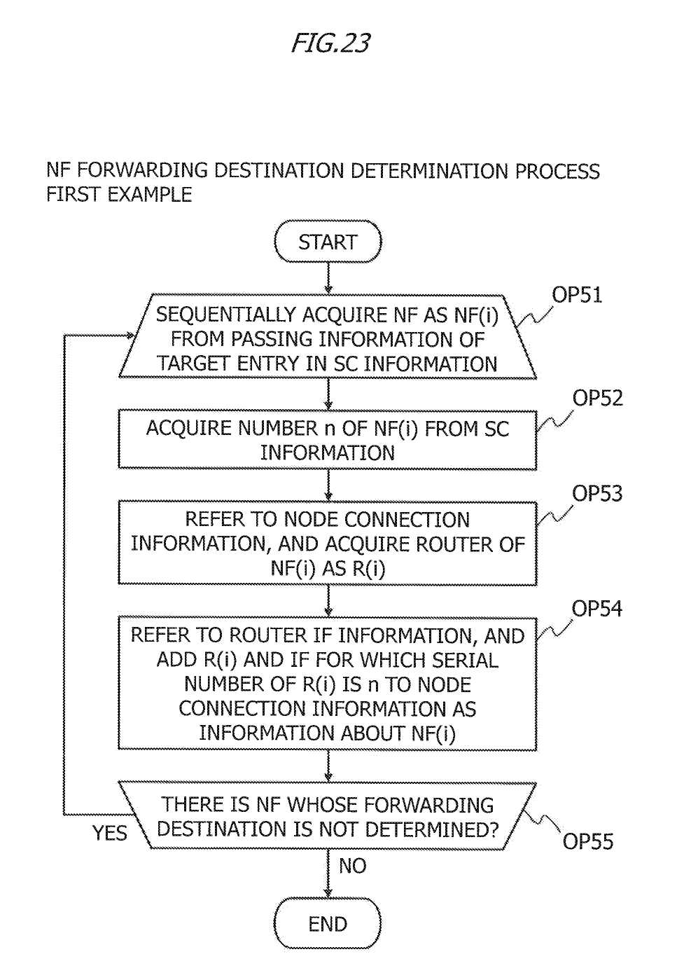

FIG. 23 is an example of a flow chart of a first example of the NF forwarding destination determination process according to the second embodiment. Also in the second embodiment, in the first example of the NF forwarding destination determination process, the interface of the router 3 to be the forwarding destination of the NF 2 is determined by associating the passing order number of the NF 2 in the SC and the serial number of the interface of the router 3. The process illustrated in FIG. 23 is started when the SC information 14 is updated by addition of a new SC or a change in an existing SC, for example. Also, the process illustrated in FIG. 23 is performed for a newly added SC or a changed SC among the SCs that are entered in the SC information 14.

In OP 51, the NF forwarding destination determination unit 11 sequentially acquires, as an NF(i), an NF 2 in the passing information of the target entry in the SC information 14. Then, the process proceeds to OP 52.

In OP 52, the NF forwarding destination determination unit 11 acquires a passing order number n of the NF(i) from the passing information of the target entry in the SC information 14. However, the source device and the destination device are not to be included in the passing order. Next, the process proceeds to OP 53.

In OP 53, the NF forwarding destination determination unit 11 refers to the node connection information 17, and acquires, as R(i), the router 3 set in the “router” of the entry for the NF(i). Next, the process proceeds to OP 54.

In OP 54, the NF forwarding destination determination unit 11 refers to the router IF information 15, and enters the IF for which the “serial number” of the R(i) is “n” and the R(i) in the entry of the NF(i) in the node connection information 17. Next, the process proceeds to OP 55.

In OP 55, the NF forwarding destination determination unit 11 determines whether or not there is an NF 2 whose forwarding destination is not yet determined, in the passing information of the target entry in the SC information 14. In the case where there is an NF 2 whose forwarding destination is not determined (OP 55: YES), the process proceeds to OP 51, and the process is repeated from OP 51 for the next NF 2. In the case where the forwarding destination is determined for all the NFs 2 in the passing information of the target entry in the SC information 14 (OP 55: NO), the process illustrated in FIG. 23 is ended. In the case where an entry of an SC with an NF 2 whose forwarding destination is not determined still remains in the SC information 14, the process in FIG. 23 is performed for the entry of the next SC.

For example, in the communication network system 100B illustrated in FIG. 20, the execution result of the first example of the NF forwarding destination determination process illustrated in FIG. 23 in a case where the SC information 14 illustrated in FIG. 5, the router IF information 15 illustrated in FIG. 21, and the node connection information 17 illustrated in FIG. 22 are set is as follows.

The passing order of the NF #1 is the first in the entry of the SC x in the SC information 14, and the router A is set for the NF #1 in the node connection information 17, and thus the IF #A1, of the router A, whose “serial number” is one in the entry of the router A in the router IF information 15 is determined. The passing order of the NF #2 is the second in the entry of the SC x in the SC information 14, and the router B is set for the NF #2 in the node connection information 17, and thus the IF #B2, of the router B, whose “serial number” is two in the entry of the router B in the router IF information 15 is determined. The passing order of the NF #3 is the third in the entry of the SC x in the SC information 14, and the router B is set for the NF #3 in the node connection information 17, and thus the IF #B3, of the router B, whose “serial number” is three in the entry of the router B in the router IF information 15 is determined.

The passing order of the NF #4 is the first in the entry of the SC y in the SC information 14, and the router B is set for the NF #4 in the node connection information 17, and thus the IF #B1, of the router B, whose “serial number” is one in the entry of the router B in the router IF information 15 is determined. The passing order of the NF #5 is the second in the entry of the SC y in the SC information 14, and the router B is set for the NF #5 in the node connection information 17, and thus the IF #B2, of the router B, whose “serial number” is two in the entry of the router B in the router IF information 15 is determined.

In the first example illustrated in FIG. 23, the passing order number of the NF 2 in the SC is in accordance with the serial number of the IF of the router 3, but this is not restrictive. The number n of the NF(i) in the SC to be acquired in OP 52 may be numbered in any way as long as there is no overlap in the same SC.

Also in the second embodiment, the second and the third examples of the NF forwarding destination determination process described in the first embodiment may be carried out in the same manner as in the first embodiment.

According to the second embodiment, even if the L2NWs connecting the NFs 2 and the routers 3 are cut off, the number of interfaces of the routers 3 for connecting the NFs 2 may be made small.

<Others>

According to the information processing apparatus and the information processing method of the disclosure, the number of used interfaces of communication devices in a system performing a predetermined process on a communication packet on a forwarding path may be made small.

In the first and the second embodiments, it is assumed that one NF 2 processes one SC, but the techniques described in the first and the second embodiments may also be applied in the case where the NF 2 includes the function for identifying packets. For example, it is possible to cause the NF 2 to process a plurality of SCs by, for example, adding the packet identification in the SC information 14 to the items of the entry in the node connection information 17, and notifying the NF 2 of the packet identification information together with the forwarding destination by the control device 1.

The techniques described in the first and the second embodiments may be applied to an SDN (Software-Defined Network) besides the IP network. In the case of an SDN, the control device 1 is replaced by a device that operates as an SDN controller, and the router 3 is replaced by a communication device that operates as an SDN switch.

<Recording Medium>

A program for causing a computer, a machine or a device (hereinafter, a computer or the like) to implement any of the functions described above may be recorded in a computer-readable recording medium. The function may be provided by causing the computer or the like to read the program from the recording medium and execute the same.

The computer-readable recording medium here is a non-transitory recording medium which stores information such as data, a program or the like by an electric, magnetic, optical, mechanical or chemical operation and which allows reading of the information by the computer or the like. Of such recording media, those that can be detached from the computer or the like includes a flexible disk, a magneto-optical disk, a CD-ROM, a CD-R/W, a DVD, a Blu-ray disc, a DAT, an 8-mm tape, a memory card such as a flash memory, and the like. Also, as recording media that are fixed to the computer or the like, there are a hard disk, a ROM (Read Only Memory), and the like. Moreover, an SSD (Solid State Drive) may be used as a recording medium that can be detached from the computer or the like, or as a recording medium that is fixed to the computer or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a storage unit that stores packet identification information that is common to packets included in a packet group that flows through a network including communication devices performing relaying, and information about network function devices selected by the packet group, each of the network function devices being connected to the communication devices via a layer 2 network, performing a predetermined process for a packet and performing input and output of the packet by a same interface;
a setting unit that sets, based on the information stored in the storage unit, one of interfaces of the communication devices as a forwarding destination of a packet input to each of the network function devices in such a way that there is no overlap between the network function devices selected by the packet group and in such a way that overlap with another network function device selected by another packet group is allowed; and
a notification unit that notifies each of the network function devices selected by the packet group of the interface of a communication device set as the forwarding destination.

2. The information processing apparatus according to claim 1, further comprising a creation unit that creates, for each of the communication devices, routing information including information about a forwarding destination of a packet according to the packet identification information and an input interface of the packet, based on forwarding destinations of the network function devices set by the setting unit,
wherein the notification unit notifies the routing information to each of the communication devices.

3. The information processing apparatus according to claim 1, wherein the setting unit determines one of the interfaces of the communication devices as a forwarding destination of a packet input to each of the network function devices by associating a number assigned to each of the network function devices selected by the packet group and a serial number assigned to each of the interfaces of the communication devices.

4. The information processing apparatus according to claim 1, wherein the setting unit determines, based on first information about one or more interfaces of the communication devices set as a forwarding destination of one or more of the network function devices selected by the packet group, one of the interfaces of the communication devices as a forwarding destination of a packet input to a network function device other than the one or more of the network function devices from among interfaces of the communication devices not set as a forwarding destination of the one or more of the network communication devices selected by the packet group.

5. The information processing apparatus according to claim 4, wherein the setting unit determines, as the forwarding destination of the packet input to the network function device, based on the first information and bandwidth information of each of the interfaces of the communication devices, an interface with a smallest bandwidth among the interfaces of the communication devices not set as a forwarding destination of the one or more of the network communication devices selected by the packet group.

6. The information processing apparatus according to claim 1, wherein the setting unit determines one of the interfaces of the communication devices as a forwarding destination of a packet input to each of the network function devices by assigning set sequence numbers to all the network function devices in such a way that the network function devices where a same packet group passes through are continuous and by associating the set sequence number and a serial number assigned to each of the interfaces of the communication devices.

7. An information processing method to be performed by a computer including a processor and a memory,
wherein the processor
stores, in the memory, packet identification information that is common to packets included in a packet group that flows through a network including communication devices performing relaying, and information about network function devices selected by the packet group, each of the network function devices being connected to the communication devices via a layer 2 network, performing a predetermined process for a packet and performing input and output of the packet by a same interface,
sets, based on the information stored in the memory, one of interfaces of the communication devices as a forwarding destination of a packet input to each of the network function devices in such a way that there is no overlap between the network function devices selected by the packet group and in such a way that overlap with another network function device selected by another packet group is allowed, and
notifies each of the network function devices selected by the packet group of the interface of a communication device set as the forwarding destination.
